(19) United States
(12) Patent Application Publication
(10) Pub. No.: US 2015/0120587 A1
(43) Pub. Date: Apr. 30, 2015

(54) USE OF A SOCIAL NETWORK TO ENHANCE HIRING TEAM COLLABORATION

(71) Applicant: Microsoft Corporation, Redmond, WA (US)

(72) Inventors: Paul R. Bramel, Fargo, ND (US); Heidi Minzner, West Fargo, ND (US); Gavin Monroe, Fargo, ND (US)

(73) Assignee: Microsoft Corporation, Redmond, WA (US)

(21) Appl. No.: 14/170,190

(22) Filed: Jan. 31, 2014

Related U.S. Application Data
(60) Provisional application No. 61/896,374, filed on Oct. 28, 2013.

(51) Int. Cl. G06Q 10/10; G06Q 50/00

(52) U.S. Cl. CPC G06Q 10/1053; G06Q 50/01
USPC 705/319

(57) ABSTRACT

A recruiting system receives user inputs that generate events within the recruiting system related to recruiting a new employee. The recruiting system tags messages with filter tags so that they can be filtered for later viewing. The recruiting system then provides outputs that take action within a social network based on user-initiated events, within the recruiting system. The recruiting system also accesses the social network to display an information feed based on user inputs.

The present application is based on and claims the benefit of U.S. provisional patent application Ser. No. 61/896,374, filed Oct. 28, 2013, the content of which is hereby incorporated by reference in its entirety.

### BACKGROUND

Many large corporations currently exist. Such corporations often have thousands, or even tens of thousands, of employees. It is common for such companies to recruit and hire many employees during a given year.

There are many different processes for hiring people in such large organizations. Most of these processes involve multiple different people, and can even involve different groups of people.

One exemplary process can include a hiring team with members that have different roles. They can include, for instance, a business person who submits a requisition for a new employee, a hiring manager, pre-screening interviewers, in-person interviewers and recruiters, among others. In order to hire a new employee, it is common for such a set of people in the organization to collaborate with one another. The hiring manager is in charge of driving the hiring process. The recruiters receive information about the open position and find candidates. The recruiters then supply information regarding the candidates to the hiring manager. The hiring manager may review the candidates' information and provide feedback and approval to the recruiter to approach the candidates. Additional interviewers may be involved to screen the candidate's information or to conduct a pre-interview telephone screen and to conduct in-person interviews.

All of the different activity that these people engage in yields communications. For instance, the hiring manager provides information to the recruiters in order to locate qualified candidates. The recruiters provide information back to the hiring manager (and perhaps other members of the hiring team) regarding potentially qualified candidates. The hiring manager and the other members of the hiring team review that information and may provide additional information to clarify the requirements for the job opening, to the recruiters. Once potentially qualified candidates are identified, pre-screening interviews can be conducted and candidates can also be brought in for in-person or other interviews. Often, multiple rounds of interviews are conducted in order to fill a position.

A great deal of communication is generated in this process. The communications can include feedback from the interviewers, ratings for individual candidates, internal discussions regarding the open positions and the candidates who are being interviewed, decisions regarding which candidates are to be interviewed and who (on the hiring team) is to conduct the interviews, among others.

Currently, these types of communications are commonly handled through electronic mail. Some of the information is contained in the body of the mail messages themselves. Other information is contained in attachments (such as when a recruiter sends a resume of a potentially qualified candidate, as an attachment). Internal conversations that are held by electronic mail can also contain valuable information. Thus, in some cases, the best repository for all of the information about an open position, or about a specific candidate, or about a set of candidates, is contained in a “sent items” folder of the electronic mail system of a hiring team manager, or other hiring team members. Often, however, all of the relevant information is not even contained in that folder. Instead, it may be spread across multiple folders, or across different folders of multiple different people.

As the number of active positions, candidates, and hiring staff increases, the amount of these communications grows proportionately and the information can be lost. Or, at the very least, it can be very difficult to retrieve. Thus, company growth can exacerbate the problem.

The discussion above is merely provided for general background information and is not intended to be used as an aid in determining the scope of the claimed subject matter.

### SUMMARY

A recruiting system receives user inputs that generate events within the recruiting system related to recruiting a new employee. The recruiting system tags messages with filter tags so that they can be filtered for later viewing. The recruiting system then provides outputs that take action within a social network based on user-initiated events, within the recruiting system. The recruiting system also accesses the social network to display an information feed based on user inputs.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative recruiting system and architecture.

FIG. 2 is a block diagram showing one embodiment of a recruiting system in more detail.

FIGS. 3A-3B (collectively FIG. 3) show a flow diagram illustrating one embodiment of the operation of the recruiting system shown in FIGS. 1 and 2.

FIG. 3C is a bock diagram of one embodiment of a set of data constructs in the recruiting system and in a social network.

FIGS. 3D and 3E show two embodiments of exemplary user interface displays.

FIG. 4 shows one embodiment of the recruiting system architecture deployed in a cloud computing architecture.

FIGS. 5-10 illustrate examples of mobile devices.

FIG. 11 is a block diagram of one illustrative embodiment of a computing environment.

### DETAILED DESCRIPTION

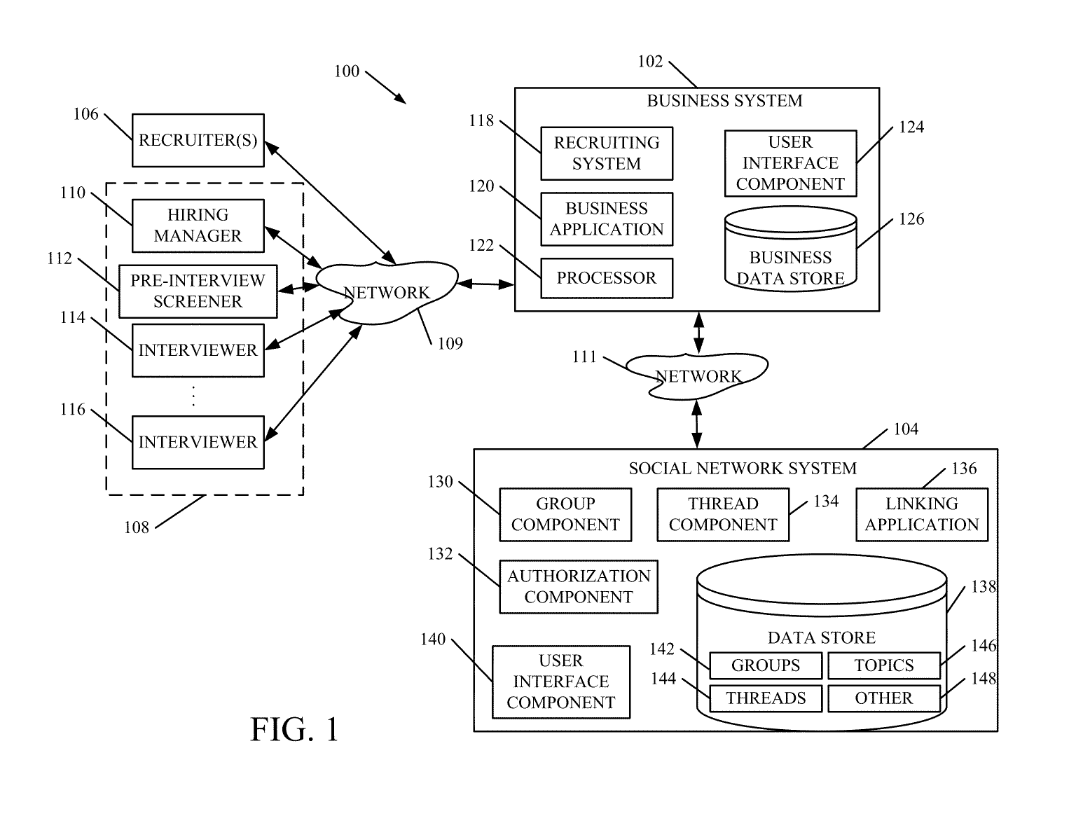

FIG. 1 is a block diagram showing one embodiment of a recruiting system architecture 100. Recruiting system architecture 100 illustratively includes business system 102 that has access to a social network system 104. FIG. 1 also shows that a plurality of different people have access to business system 102. In one embodiment, the people include one or more recruiters 106 and a hiring team 108. Hiring team 108, itself, illustratively includes a hiring manager 110, one or more pre-interview screeners 112, and a set of interviewers 114 and 116. The hiring team 108 is exemplary only and can include additional or different members as well.

FIG. 1 also shows that team members 108 and recruiters 106 can access business system 102 over network 109. In addition, business system 102 illustratively accesses social network system 104 over network 111. It will be appreciated that networks 109 and 111 can be the same network or different networks. They can also be a local area network, a wide area network, or other types of networks.

Business system 102 can be one of a wide variety of different kinds of business systems. For instance, it can be an enterprise resource planning (ERP) system, a customer relations management (CRM) system, a line-of-business (LOB) system, among others. In the embodiment described herein, system 102 will be described as an ERP system, although that description is provided for the sake of example only.

Business system 102 illustratively includes recruiting system 118, business applications 120, processor 122, user interface component 124 and business data store 126. It can include other components, or items, or systems as well.

Business data store 126 illustratively includes business data (such as entities), workflows, other business data records, and other information. The entities illustratively represent different items associated with the business that is using business system 102. For instance, a customer entity may represent a customer. A vendor entity can represent a vendor. A product entity can represent a product. A business opportunity entity can represent a business opportunity. A candidate requisition entity can represent a requisition for a candidate or for a new employee. A candidate entity can represent a candidate, etc.

Business applications 120 illustratively operate on the data and workflows and other information stored in data store 126 to enable users to perform activities, tasks, or other operations in order to conduct the business of the organization that is using system 102. For instance, applications 102 can include inventory applications, sales applications, general ledger applications among others.

In one embodiment, user interface component 124 (either under the control of other components or systems in business system 102, or by itself) illustratively generates a set of user interface displays with user input mechanisms that a user can interact with, in order to manipulate and control business system 102. For instance, user interface component 124 can generate a set of user interface displays, with user input mechanisms, that can be actuated by recruiters 106 and members of hiring team 108, in order to manipulate and control recruiting system 118. This is described in greater detail below.

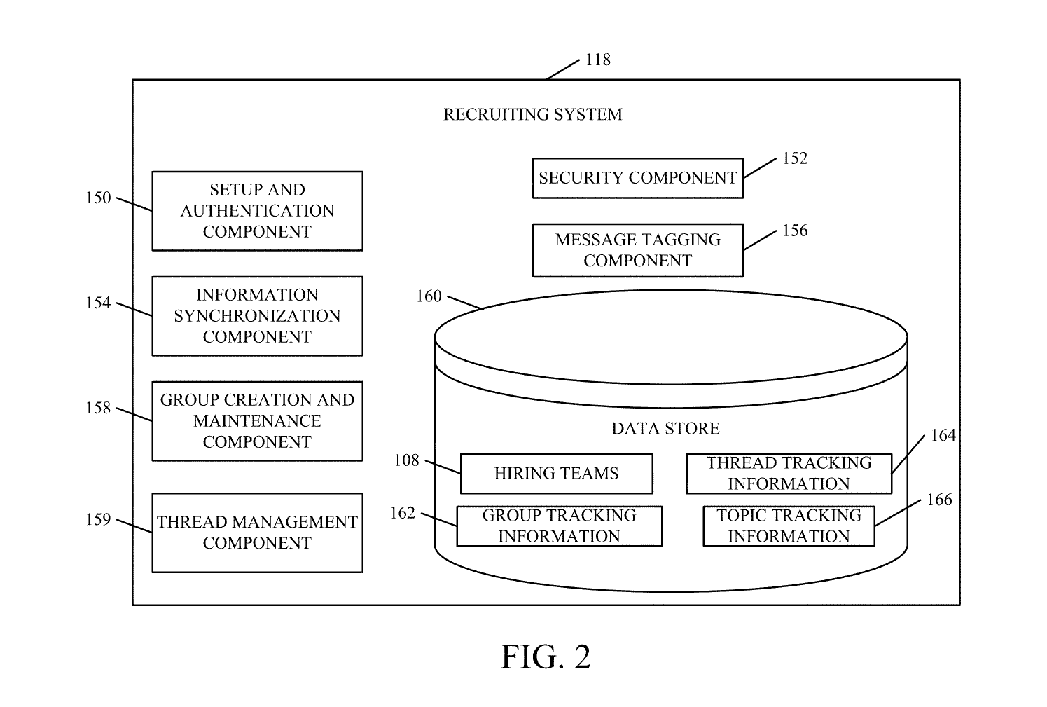

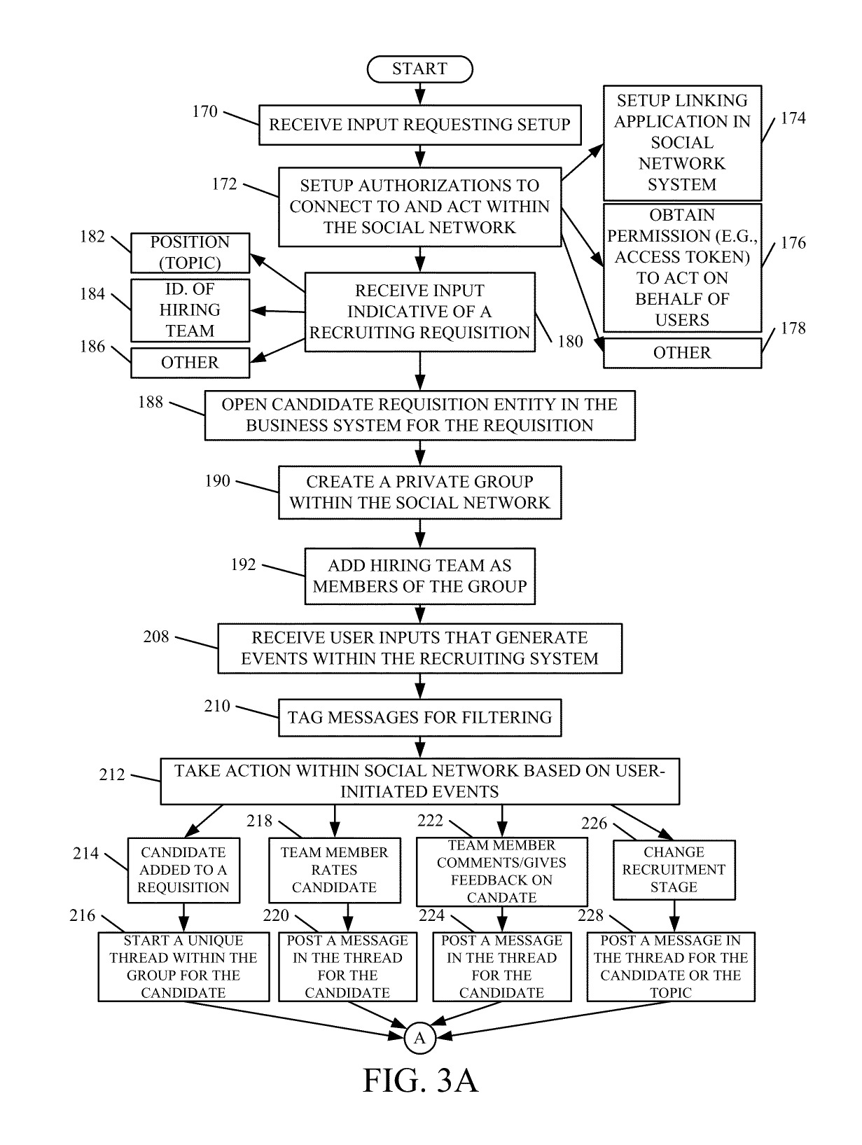

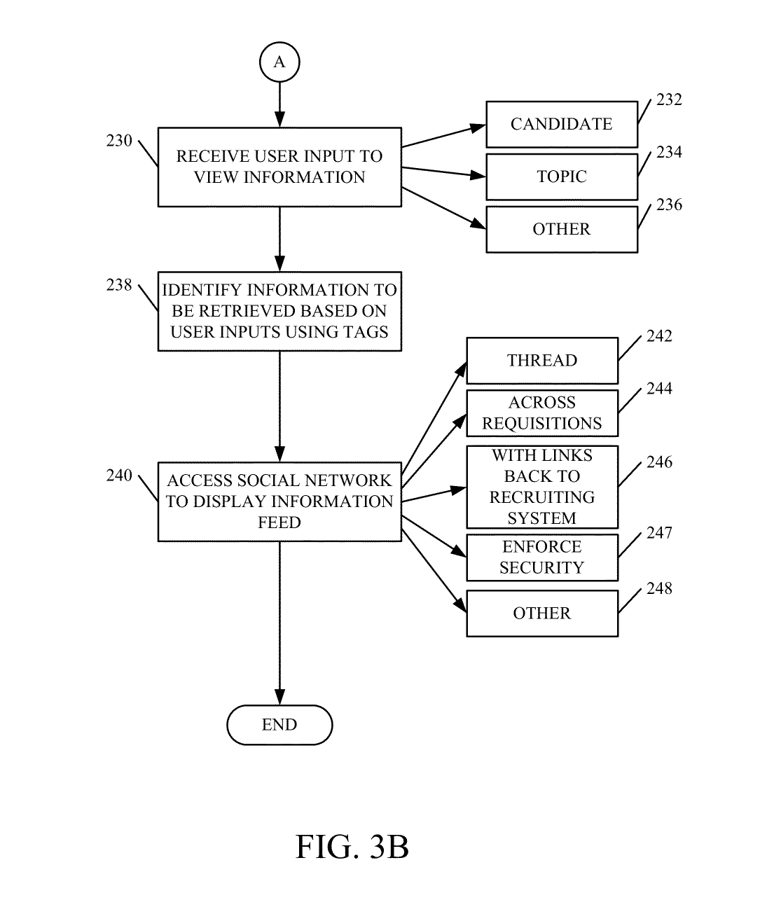

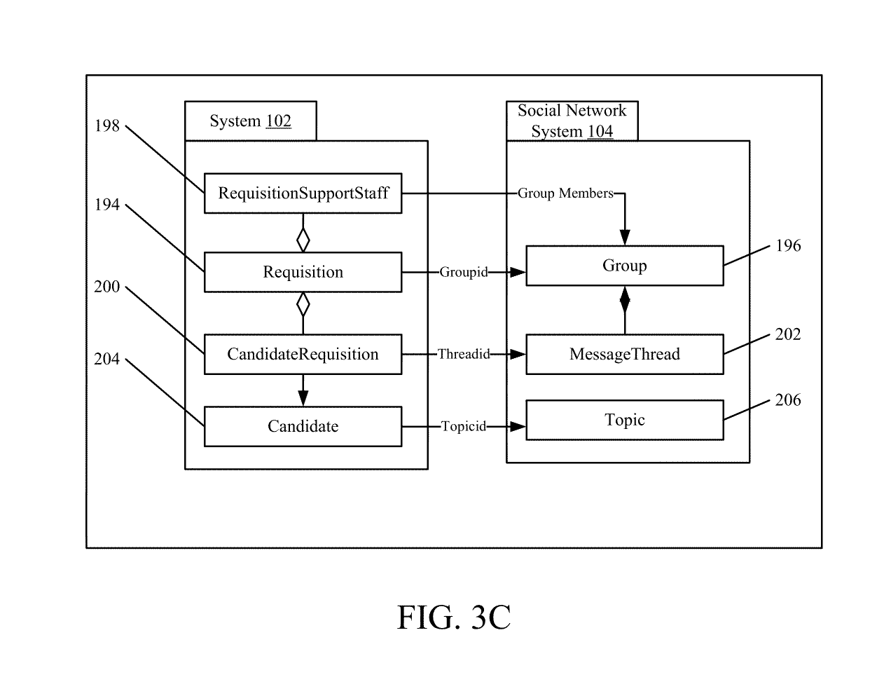

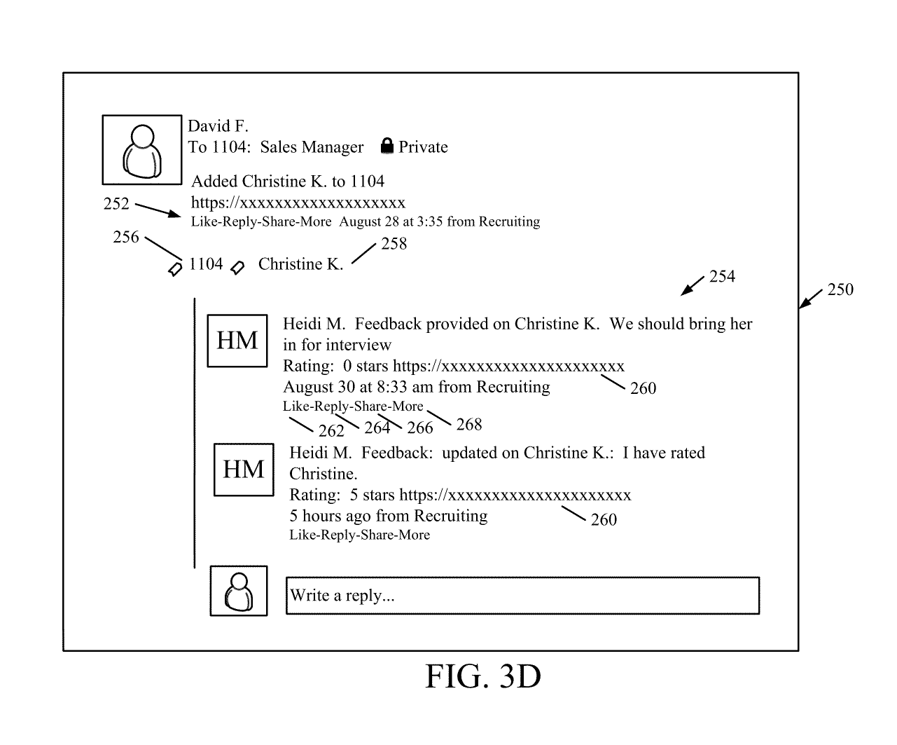

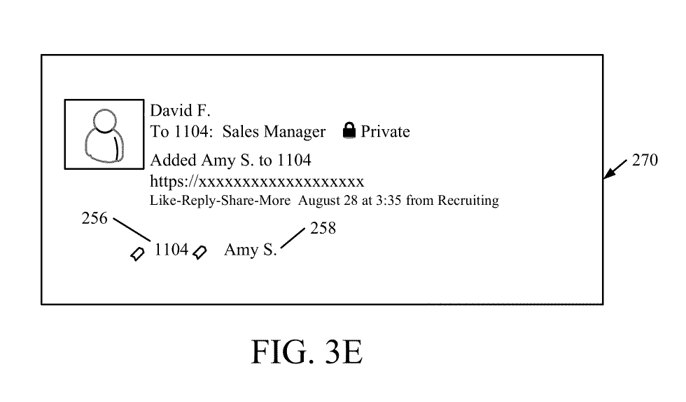

Recruiting system 118 illustratively allows recruiters 106 and hiring team 108 to collaborate with one another in carrying out the process of hiring a new employee. This is also done in collaboration with certain portions of social network system 104. This is described in greater detail below with respect to FIGS. 2-3E.

FIG. 1 also shows that social network system 104 illustratively includes group component 130, authorization component 132, thread component 134, linking application 136, data store 138 and user interface component 140. Data store 138 illustratively stores groups 142, various threads 144, topics 146 and other information 148.

Social network system 104 is illustratively a computer system that implements social network services. A user can illustratively create a social network site (or account) that is connected to social network sites (or accounts) of others through a social media service. The social network connections between a given user and other users of the social media are sometimes referred to as the given user's social graph. The graph can sometimes include connection to other users of the social media service, but it can also sometimes include connections to a given subject matter area, various products, or groups, etc.

In the context of the present discussion, social network system 104 also provides functionality for creating a private group. A private group is a group that can have members added only by certain authorized personnel. Group component 130 and authorization component 132, are illustratively accessed by a user (or in the present discussion by recruiting system 118) in order to set up groups. Thread component 134 organizes, manages and presents for viewing, threaded communications or conversations based upon various inputs. Linking application 136 is illustratively used to link recruiting system 118 to social network system 104, and allow recruiting system 118 to make certain changes within social network system 104. The groups 142 and threads 144 can be stored in data store 138. In addition, social network system 104 illustratively keeps a set of topics 146 that can be used to cross-reference or index information provided to a user as well.

Before describing the operation of architecture 100 in more detail, a brief overview will be provided to enhance understanding. When a member of the organization that uses business system 102 wishes to hire a new employee, that user illustratively inputs an employee requisition or a candidate requisition to obtain information about potentially qualified candidates. When that happens, recruiting system 118 illustratively sets up a connection with social network system 104 and uses group component 130 to create a private group 142 within social network system 104. Various members are then added to the group (such as members of hiring team 108) and recruiters 106. Potentially qualified candidates can then be associated with the requisition and a unique message thread 144 is illustratively generated by thread component 134 in social network system 104. In doing so, recruiting system 118 receives the identity of the candidate from one of hiring team 108 or recruiters 106, and provides information to thread component 134 in order to generate a unique thread 144 within the group 142 corresponding to the requisition for which the candidate is being considered. As members of hiring team 108 or recruiters 106 take actions within recruiting system 118, recruiting system 118 provides inputs to social network system 104 to post messages to the group 142 corresponding to the requisition. By way of example, when hiring manager 110 inputs feedback about a candidate to recruiting system 118, recruiting system 118 accesses thread component 134 in social network system 104 to post a message to the appropriate thread 144 corresponding to that candidate, in the appropriate group 142, corresponding to the requisition. When any of the members that have access to that information desire to view the threads, they can provide filter inputs (through appropriate user input mechanisms—some of which are discussed below) to recruiting system 118. Recruiting system 118 then uses an embedded feed control in social network system 104 to display a message feed corresponding to the candidate, or corresponding to the requisition, or both.

FIG. 2 is a more detailed block diagram of recruiting system 118. FIG. 2 shows that recruiting system 118 illustratively includes setup and authentication component 150, security component 152, information synchronization component 154, message tagging component 156, group creation and maintenance component 158, thread management component 159, and data store 160. Data store 160, itself, illustratively includes the information identifying the hiring teams 108, group tracking information 162, that enables recruiting system 118 to track and access the various groups 142 within social network system 104, thread tracking information 164 that enables recruiting system 118 to access and track the various threads 144 in social network 104, and topic tracking information 166 that enables recruiting system 118 to track and access the various topics 146 within social network system 104.

FIGS. 3A and 3B (collectively FIG. 3) show a flow diagram illustrating the operation of recruiting system 118, in collaboration with social network system 104, in more detail. In one embodiment, setup and authentication component 150 first receives an input from a user requesting that recruiting system 118 set up a connection to a social network system 104, in order to perform recruiting activities. This is indicated by block 170 in FIG. 3.

Setup and authentication component 150 then sets up the authorizations that are needed to connect to and act within social network system 104. This is indicated by block 172 in FIG. 3, and it can be done in a variety of different ways. In one embodiment, setup and authentication component 150 illustratively sets up linking application 136 in social network system 104. This is indicated by block 174 in FIG. 3. The linking application 136 illustratively enables recruiting system 118 to access the various components of social network system 104, and to take action within social network 104.

Setup and authentication component 150 then also illustratively obtains permission from the various users in hiring team 108 and recruiters 106 to act on their behalf within social network system 104. This is indicated by block 176 in FIG. 3. By way of example, setup and authentication component 150 can interact with the various devices being used by hiring team 108 and recruiters 106 to access system 118 and obtain an access token which setup and authentication component 150 can use in social network system 104 to act on behalf of the various members of hiring team 108 and recruiters 106. It will also be noted, of course, that setup and authentication component 150 can set up the connection to social network system 104 in other ways as well. This is indicated by block 178 in FIG. 3.

Once the connection between recruiting system 118 and social network system 104 is set up, group creation and maintenance component 158 illustratively receives an input from a user of system 102 indicative of a recruiting requisition. By way of example, a business manager or member of hiring team 108 or recruiters 106 may provide an input to business system 102 indicating that a new employee has been requisitioned. This is indicated by block 180 in FIG. 3, and it can be done in a number of different ways. For instance, the user input can include a description of the position for which the candidate is being sought. This can also be indicative of a topic within social network system 104. This is indicated by block 182 in FIG. 3.

The user input can also provide the identity of the various members of hiring team 108 and recruiters 106. This is indicated by block 184 in FIG. 3. The user inputs indicative of a recruiting requisition can include other information as well, and this is indicated by block 186.

Group creation and maintenance component 158 then opens a candidate requisition entity in business system 102, corresponding to the requisition. This is indicated by block 188 in FIG. 3. Group generator and maintenance component 158 then interacts with group component 130 to create a private group 142 within social network system 104 (this can be done through linking application 136 as well). This is indicated by block 190 in FIG. 3. Group creation and maintenance component 158 then illustratively adds the hiring team members and recruiters that were identified in the recruiting requisition (or otherwise) to the private group which has just been created, and which corresponds to that requisition. Adding the hiring team as members of the private group is indicated by block 192 in FIG. 3. Also, if a hiring team member is later removed from hiring time 108, that member is removed from group 142 as well.

FIG. 3C shows one embodiment of various data constructs that are illustratively generated within business system 102, by recruiting system 118, and within social network system 104, also under the direction of recruiting system 118 or linking application 136. It can be seen that a requisition entity 194 is opened within business system 102, once a requisition has been received. Also, in response to the requisition entity 194 being opened, a private group 196 is opened within social network system 104. Requisition support staff node 198 shows that group members can be added to the private group 196, once it has been created. For instance, the group members may illustratively include the members of hiring team 108 and recruiters 106.

When a specific candidate 204 is identified, a candidate requisition entity 200 is also illustratively opened within business system 102. This causes thread management component 159 to interact with thread component 134 in social network system 104 to open a unique message thread 202 in social network system 104, corresponding to that given candidate 204. The specific candidate 204 is also tagged as corresponding to a given topic 206. That is, each candidate 204 is assigned a unique topic identifier so that the candidate information can be viewed across various requisitions. By way of example, if a single candidate has applied for, and is being considered for, multiple open positions, the information for that candidate, if it is cross-referenced or indexed by topic 206, can be viewed across multiple different requisitions. This is described in greater detail below.

Referring again to the flow diagram of FIG. 3, recruiting system 118 then receives various different inputs from hiring team 108 and recruiters 106, that generate events within recruiting system 118. This is indicated by block 208 in FIG. 3. A number of examples of these types of events are discussed with respect to FIG. 3 below. It will be noted, however, that messages are generated based on some of these events. The messages are illustratively tagged by message tagging component 156 so that they can be filtered later, during viewing. This is indicated by block 210 in FIG. 3.

Recruiting system 118 then takes various different actions within social network system 104 based on the user-initiated events. This is indicated by block 212. For instance, one of the users can add a candidate to the requisition. This is indicated by block 214. When that happens, thread management component 159 within recruiting system 118 interacts with thread component 134 in social network system 104 to start a unique thread within the group (corresponding to the requisition for which the candidate has been added) for that specific candidate. This is indicated by block 216 in FIG. 3.

Another user-initiated event may be generated when a member of hiring team 108 rates a candidate on one of a variety of different rating criteria. As a simple example, a candidate's resume may be rated on a scale of 1-5 based upon how qualified the interviewer believes that candidate will be for the given requisition. In that case, information synchronization component 154 posts a message in the thread that has been opened for that specific candidate. Receiving an input from a team member rating the candidate is indicated by block 218 in FIG. 3 and posting a message in the thread for that candidate is indicated by block 220.

Another user-initiated event can be generated in system 218 when a hiring team member comments or provides feedback on a candidate. This is indicated by block 222. In that case, information synchronization component 154 also posts a message in the thread, for that candidate. This is indicated by block 224 in FIG. 3.

As another user-initiated event, a user may change the recruitment stage corresponding to a candidate. For instance, each candidate may have a corresponding stage indicator, indicating where that candidate is in the recruitment process. One stage may be, for example, “hiring manager to review resume”. A next stage may be “interview candidate”, yet another stage may be “call back for second interview” and a different stage may be “make an offer”. These, of course, are exemplary stages only. However, when a user changes the recruitment stage corresponding to a given employee (or to a requisition for that matter—such as changing the stage from “actively recruiting” to “position filled”), then information synchronization component 154 illustratively posts another message in the thread for the candidate, or in the topic area corresponding to the requisition. Receiving a user input changing the recruitment stage is indicated by block 226 in FIG. 3, and posting a message in the thread for the candidate or the topic is indicated by block 118.

These are exemplary user-initiated events only. A wide variety of other or additional user-initiated events can be generated as well.

It will be appreciated that, while users are providing input as discussed above, they can also illustratively be viewing the message feeds for the various candidates, requisitions, topics, etc. In order to do so, information synchronization component 154 illustratively receives a user input indicating that a user wishes to view a message feed. This is indicated by block 230 in FIG. 3. The user can provide this by identifying a candidate 232 for which the user wishes to view a message thread. The user can also illustratively do this by specifying a topic 234. Information synchronization component 154 illustratively provides this information to user interface component 140 in social network system 104. User interface component 140 illustratively identifies the information retrieved from data store 138, based upon the tags that have been added to that information by message tagging component 156 in system 118, and based upon the particular user input information input by the user specifying the information they wish to view. Again, for instance, if the user selects a candidate 232, then user interface component 140 illustratively generates a message feed corresponding to the thread for that candidate. If the user specifies a topic 234, user interface component 140 illustratively generates a message feed corresponding to that topic. Retrieving the information from data store 138 based upon the user inputs and based upon the tags for that information is indicated by block 238 in FIG. 3. Having information synchronization component 154 access social network 104 to obtain the message feed corresponding to the user inputs is indicated by block 240.

The message feed can, in one embodiment, be a thread corresponding to a candidate, as indicated by block 242. It can display information from a plurality of different threads, across various groups (e.g., across various requisitions) where that candidate is being considered for different positions. This is indicated by block 244 in FIG. 3.

The message feed can also include links back to recruiting system 118. By way of example, if business data store 126 or data store 160 in recruiting system 118 contains additional information that may not be found on social network system 104, (such as salary information or other information) that information can be linked to in various messages or in the message feed itself. When the user is viewing that information, the user can illustratively actuate that link to be navigated back to a view of the corresponding information within recruiting system 118. Providing the message feed with links back to system 118 is indicated by block 246. The information in the message feed can include other information as well. This is indicated by block 248 in FIG. 3.

While the message feed is being displayed at block 240, it will be noted that, in one embodiment, security component 152 enforces security with respect to the message feed that is displayed. By way of example, if a member of a first hiring team is viewing information on a candidate, and wishes to view information for that candidate across multiple requisitions, that member may not be a member of all hiring teams. Therefore, security component 156 ensures that the user who is attempting to view information actually has authorization to view that information. In one embodiment, for instance, security component 152 checks to determine whether the user is a member of the hiring team for which he or she is seeking to view information. Security component 152 can also perform role-based security. By way of example, it may be that users in the human resources department, overall, have more access to personnel information than users in the sales department. Thus, even though a member of a sales department is on one or more hiring teams, that person may not get to view all of the information that a member of the human resources department can view. Of course, security component 152 can implement other security as well.

FIGS. 3D and 3E show various embodiments of user interface displays that indicate some of the functionality discussed above. FIG. 3D is one embodiment of a user interface display 250 that shows a message thread corresponding to a given candidate. FIG. 3D shows that a hiring manager Dave F. has added a candidate Christine K. to a requisition identified by a requisition number (in this case it is number 1104) and a label (in this case “Sales Manger”) that indicates the position for which a candidate is being sought. Dave F.'s position is displayed as “hiring manager” and a message shown generally at 252 indicates that Dave F. has added Christine K. to the requisition 1104. A message thread shown generally at 254 is also displayed. The message thread 254, in the embodiment shown in FIG. 3D, includes messages posted in response to user-initiated events in system 118. In the embodiment shown, the thread includes the requistion identifier 1104 shown at 256, and the candidate identifier (Christine K.) shown at 258.

Identifiers 256 and 258 are illustratively user actuatable input mechanisms. For instance, they can be actuated by a user to change the message feed that is displayed. It can be seen in FIG. 3D that the user has actuated the Christine K. candidate identifier 258. Thus, message thread 254 shows messages in the thread corresponding to the candidate Christine K. The first message is feedback that was provided by a team member Heidi M. In the example, the feedback indicates that it was provided for candidate Christine K. and the feedback content is “we should bring her in for interview.” The feedback display also illustratively includes a link 260 that links back to a rating system within recruiting system 118. The user can actuate link 260 in order to provide a rating for the candidate Christine K. in system 118. The second message is an updated message showing that the rating link 260 has been updated from “0 stars” to “5 stars”. It can also be seen that, in one embodiment, all of the entries in the message thread include various interactive elements such as “like” element 162, “reply” element 264, “share” element 266 and “more” element 268. Each of the elements 262-268 can be actuated by the user to provide further information, with respect to the displayed message.

FIG. 3E shows another message feed in user interface display 270. FIG. 3E shows that, in one embodiment, the user has actuated the requisition user input mechanism 256 in FIG. 3D. Thus, the message feed shown in display 270 is requisition-specific information, instead of candidate-specific information. In the embodiment illustrated, the message feed indicates that Dave F. has added a new candidate (Amy S.) to the requisition identified by requisition identifier 1104. The message feed shown in display 270 also includes requisition user input mechanism 256 and candidate user input mechanism 258. The requisition mechanism 256 can be actuated to display additional information about the topic (this particular candidate requisition), and candidate mechanism 256 can be actuated to show a message feed that is specific to the identified candidate (Amy S.) across multiple requisitions.

It can thus be seen that recruiting system 118 illustratively provides social network group creation and membership maintenance for recruiting collaboration of a recruiting team or other individuals. Recruiting system 118 generates messages to a private social network group based on user-initiated events. It can also tag those messages to enable filtering and cross-team view of candidate feedback. When viewing a requisition in system 118, the social network system embedded feed control can be used to display a message feed for a group corresponding to that requisition. When viewing candidate information in system 118, the embedded feed control of the social network system can be used to display a message feed for the candidate across requisitions, by pointing the view control to the topic associated with the candidate.

In one embodiment, recruiting information discussed herein can be viewed in other ways as well. For instance, it can be viewed through the normal social networking website of system 104, as well as through the embedded feed control. In addition, candidates can be represented in other ways as well. For example, a candidate can be represented using a webpage that has the same functionality as any object within social network system 104. This can be done using a wide variety of different technologies and schemas, or by using a given protocol, such as Open Graph protocol, or others.

The above discussion has proceeded with respect to processor 122, and data stores 126, 138 and 160. A number of things will be appreciated. First, there can be multiple processors, instead of only processor 122. In addition, there can be a processor within social network system 104, or within devices that the users are using to access system 102. The processors are illustratively computer processors with associated memory and timing circuitry (not separately shown). They are illustratively a functional part of the system to which they belong, and are activated by, and facilitate the functionality of, other items, components, or systems, of the system to which they belong.

Data stores 126, 138 and 160 are all shown as single data stores and they are local to the systems accessing them. It will be appreciated that they can each be formed of multiple different data stores, and all of them can be local or remote, or some can be local while others are remote.

Further, the above discussion has mentioned a number of user interface displays, with corresponding user input mechanisms. The user interface displays that are discussed above are exemplary only, and a wide variety of other user interface displays can be used as well. In addition, the user input mechanisms discussed above are exemplary only and other user input mechanisms can also be used. For instance, the user input mechanisms can be links, icons, buttons, drop down menus, text boxes, search boxes, check boxes, etc. They can also be actuated in a wide variety of different ways. For instance, they can be actuated using hardware components, such as a point and click device (e.g., a mouse or track ball), a keyboard, a keypad, buttons, joysticks, thumb pads, thumb switches, etc. Further, they can also be actuated using virtual components, such as a virtual keyboard or keypad, a thumb pad, or other virtual actuators. If the display screen on which they are displayed is a touch sensitive screen, they can also be actuated using touch gestures (such as with a user's finger, a stylus, etc.). In addition, where the device with which they are used includes speech recognition components, they can be actuated using speech commands.

The above figures also show various blocks that have various functionality ascribed to them. It will be noted, that however, that additional blocks can be used with the functionality distributed among the additional blocks. In addition, the blocks shown can be combined into fewer blocks that perform the same functionality.

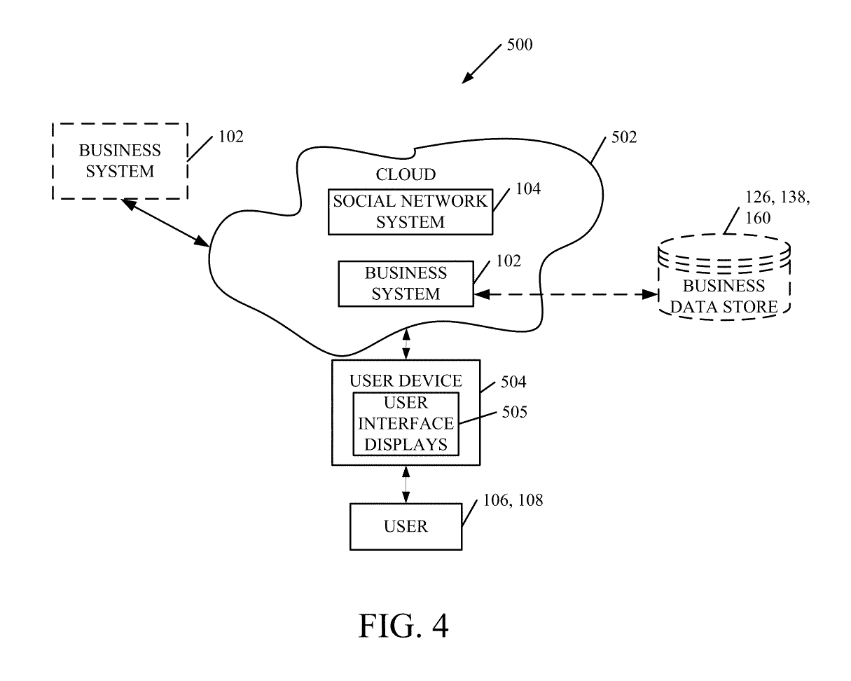

FIG. 4 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 4, some items are similar to those shown in FIG. 1 and they are similarly numbered. FIG. 4 specifically shows business system 102 and social network system 104 located in cloud 502 (which can be public, private, or a combination where portions are public while others are private). Therefore, users 106, 108 use user devices 504 that generate user interface displays 505 to access those systems through cloud 502.

FIG. 4 also depicts another embodiment of a cloud architecture. FIG. 4 shows that it is also contemplated that some elements of architecture 100 are disposed in cloud 502 while others are not. By way of example, data stores 126, 138 and 160 can be disposed outside of cloud 502, and accessed through cloud 502. In another embodiment, business system 102 is also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

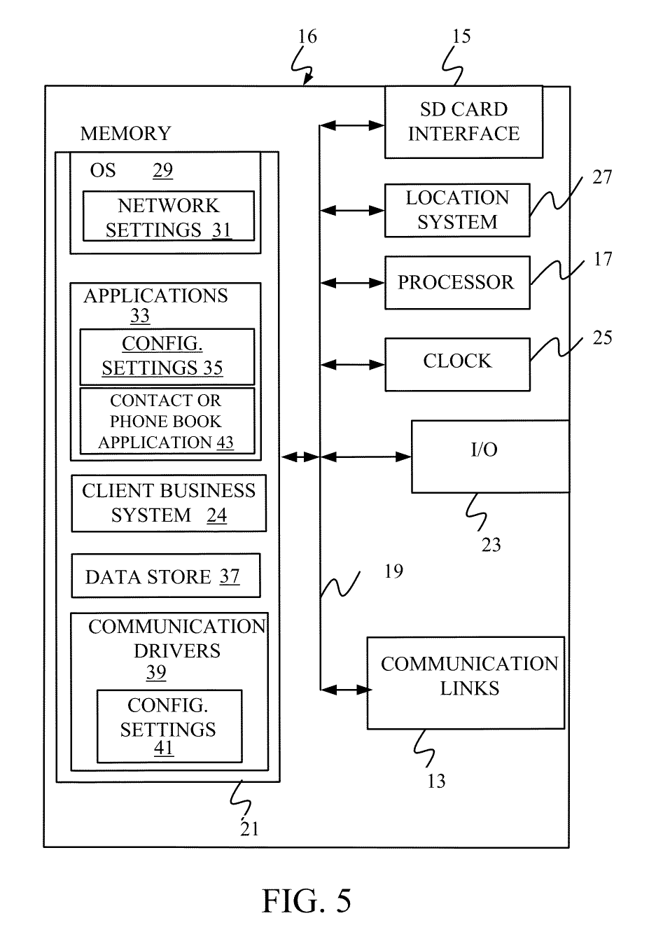

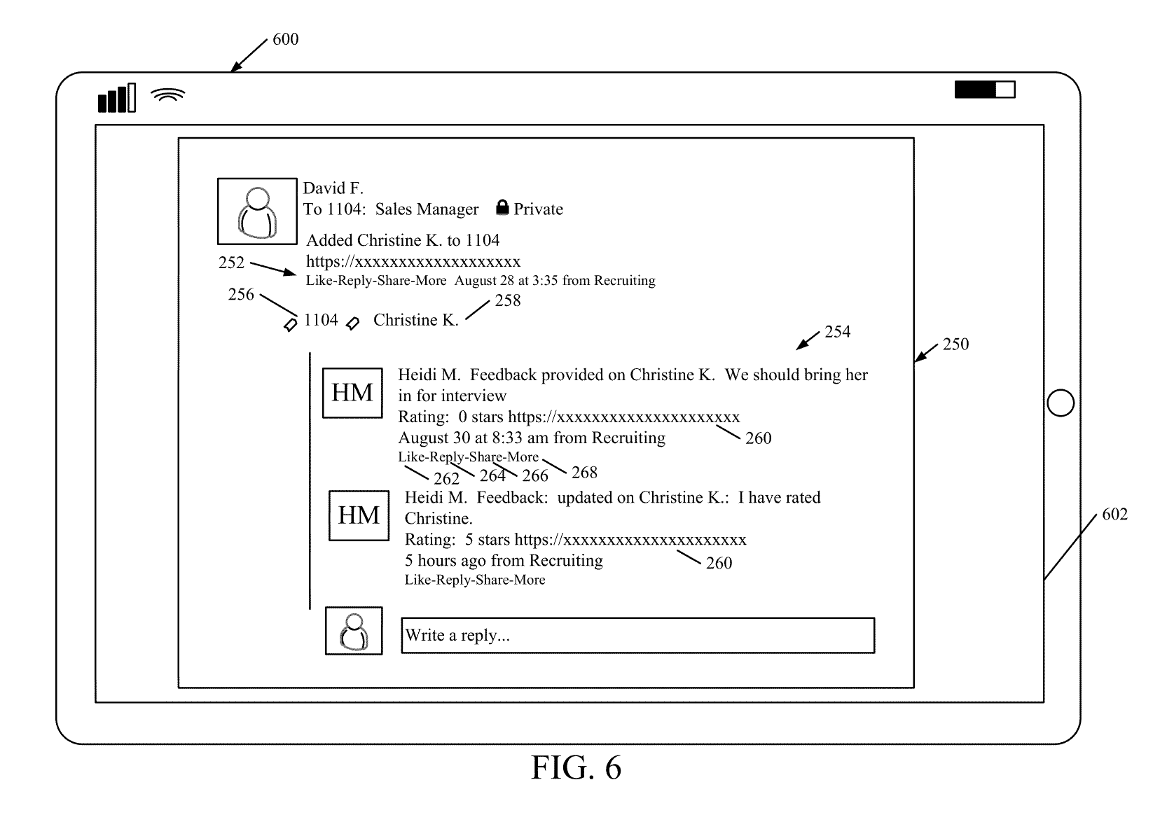

FIG. 5 is a simplified block diagram of one illustrative embodiment of a handheld or mobile computing device that can be used as a user's or client's hand held device 16, in which the present system (or parts of it) can be deployed. FIGS. 6-10 are examples of handheld or mobile devices.

FIG. 5 provides a general block diagram of the components of a client device 16 that can run components of architecture 100 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processors 122 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client business system 24 which can run various business applications. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 6 shows one embodiment in which device 16 is a tablet computer 600. In FIG. 6, computer 600 is shown with user interface display from FIG. 3D displayed on the display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

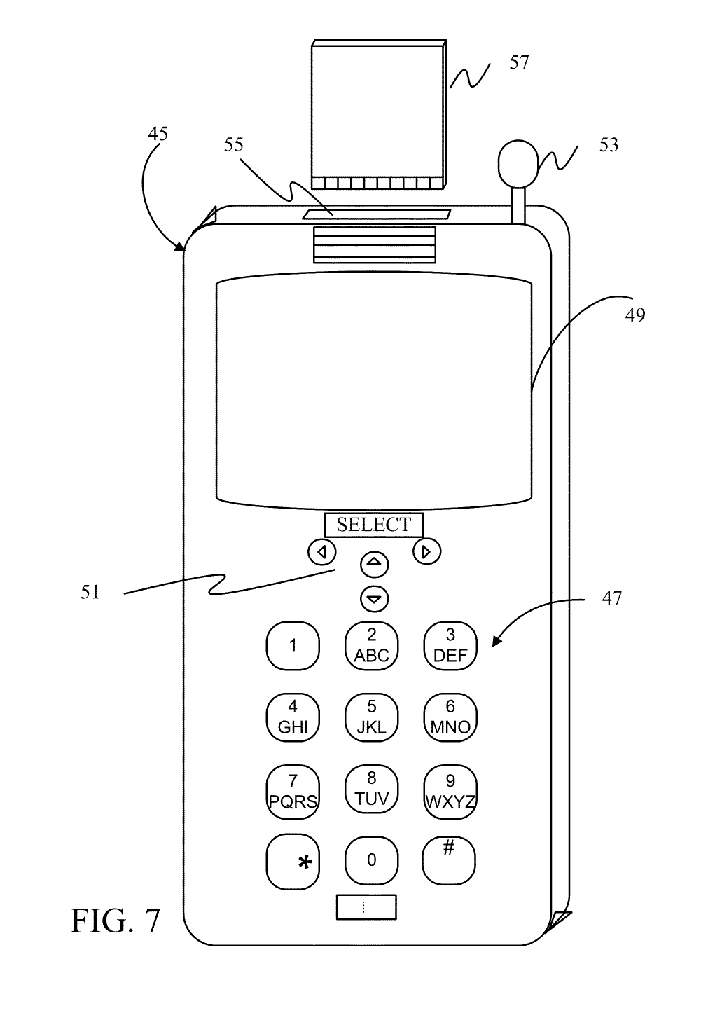

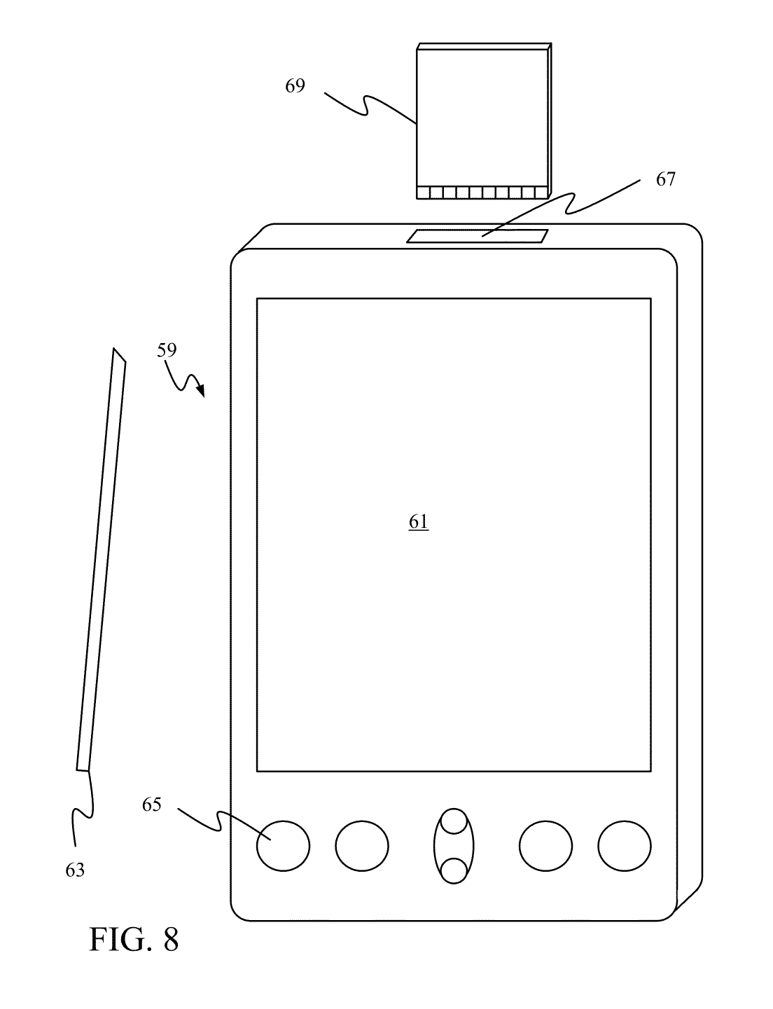

FIGS. 7 and 8 provide additional examples of devices 16 that can be used, although others can be used as well. In FIG. 7, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 8 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

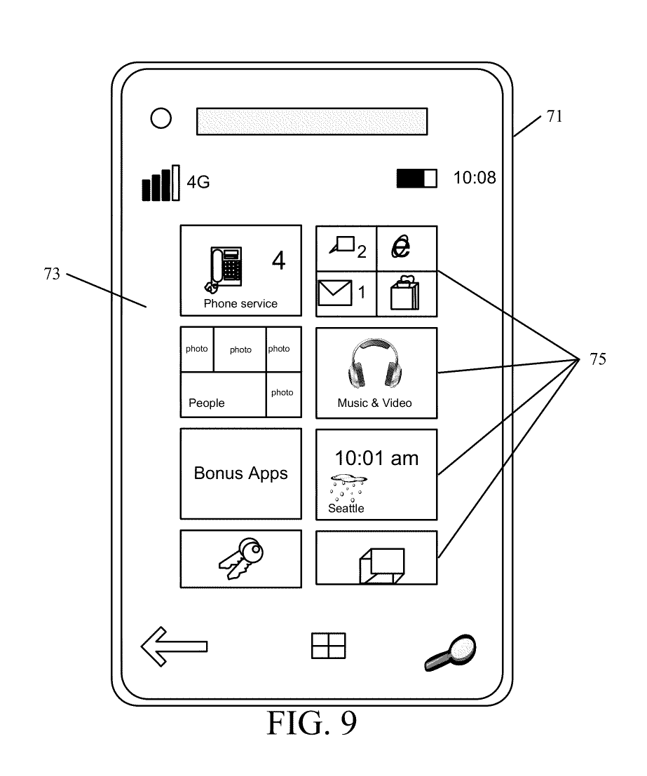

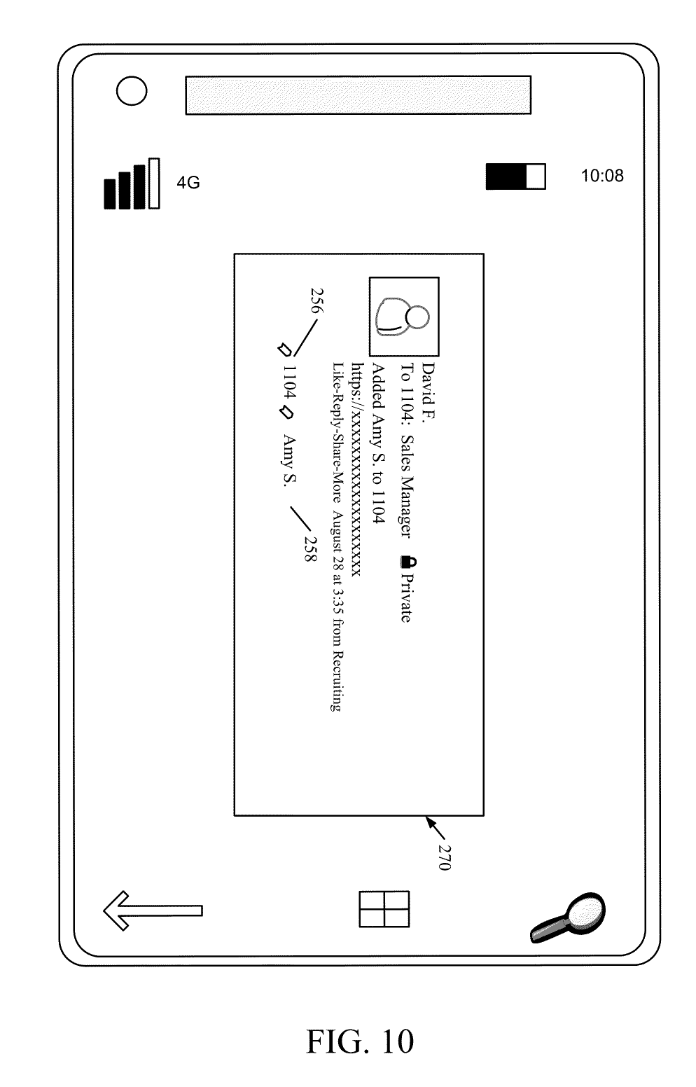

FIG. 9 is similar to FIG. 7 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone. FIG. 10 shows phone 71 with the display of FIG. 3E displayed thereon.

Note that other forms of the devices 16 are possible.

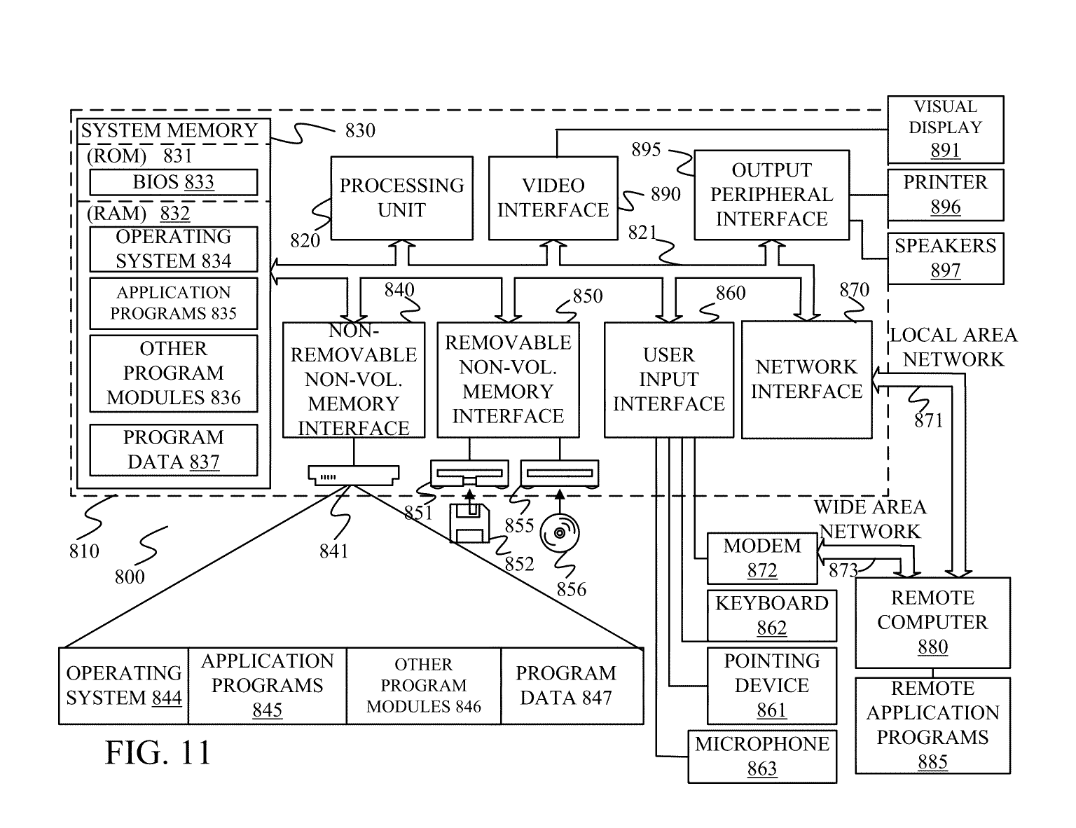

FIG. 11 is one embodiment of a computing environment in which architecture 100, or parts of it, (for example) can be deployed. With reference to FIG. 11, an exemplary system for implementing some embodiments includes a general-purpose computing device in the form of a computer 810. Components of computer 810 may include, but are not limited to, a processing unit 820 (which can comprise processor 122), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 11 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 11 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented method, comprising:
receiving a requisition input indicative of a recruiting requisition and a set of recruiting personnel;
outputting a private group output creating a private group in a social network corresponding to the recruiting requisition;
adding the recruiting personnel to the private group in the social network;
receiving user event inputs that generate a user-initiated recruiting event; and
outputting an action output performing an action in the social network based on the user-initiated event.

2. The computer-implemented method of claim 1 and further comprising:
opening a recruiting requisition record corresponding to the recruiting requisition.

3. The computer-implemented method of claim 2 wherein outputting an action output comprises:
outputting a thread manipulation output manipulating a thread, corresponding to a candidate, in the private group in the social network.

4. The computer-implemented method of claim 3 wherein receiving the user event input comprises:
receiving a user event input adding a new candidate to the requisition record.

5. The computer-implemented method of claim 4 wherein outputting a thread manipulation output comprises:
outputting a thread starting output starting a unique thread corresponding to the new candidate within the private group in the social network.

6. The computer-implemented method of claim 3 wherein receiving the user event input comprises:
receiving a rating input indicative of a member of the set of hiring personnel rating a given candidate in the recruiting requisition record.

7. The computer-implemented method of claim 6 wherein outputting a thread manipulation output comprises:
posting a rating message, indicative of the rating, in a given thread in the social network corresponding to the given candidate.

8. The computer-implemented method of claim 3 wherein receiving the user event input comprises:
receiving a feedback input indicative of a member of the set of hiring personnel providing feedback on a given candidate in the requisition record.

9. The computer-implemented method of claim 8 wherein outputting a thread manipulation output comprises:
posting a feedback message, indicative of the feedback, in a given thread in the private group of the social network corresponding to the given candidate.

10. The computer-implemented method of claim 3 wherein receiving the user event input comprises:
receiving a recruiting stage change input indicative of a change in a recruitment stage corresponding to a given candidate.

11. The computer-implemented method of claim 10 wherein outputting a thread manipulation output comprises:
posting a stage change message, indicative of the recruiting stage change, in a given thread in the private group of the social network corresponding to the given candidate.

12. The computer-implemented method of claim 3 and further comprising:
tagging messages in the thread with filter tags identifying a candidate, a topic and a requisition.

13. The computer-implemented method of claim 12 and further comprising:
receiving a user access input to access the thread; and
displaying the thread from the social network based on the user access input.

14. The computer-implemented method of claim 13 wherein the user access input includes a tag identifier and wherein displaying the thread comprises:
displaying thread information across multiple recruiting requisitions based on the tag identifier.

15. The computer-implemented method of claim 13 wherein the user access input includes a tag identifier and wherein displaying the thread comprises:
displaying thread information across multiple recruiting candidates based on the tag identifier.

16. A computer system, comprising:
a group creation component receiving a requisition input indicative of a recruiting requisition and a set of recruiting personnel and creating a private group in a social network corresponding to the recruiting requisition, the group including the recruiting personnel;
a thread management component that receives a user event input that generates a user-initiated recruiting event and outputs an action output performing an action in the social network based on the user-initiated event; and
a computer processor that is a functional part of the system and activated by the group creation component and the thread management component to facilitate creating the private group and generating the action output to perform the action in the social network.

17. The computer system of claim 16 wherein the group creation component and the thread management component are part of a recruiting system within a business system.

18. The computer system of claim 16 wherein the action in the social network comprises a thread manipulation action manipulating a thread in the private group in the social network and further comprising:
a message tagging component that generates tags for messages in the thread, the thread management component filtering the messages in response to a thread accessing input based on the tags.

19. A computer readable storage medium storing computer executable instructions which, when executed by a computer, cause the computer to perform a method, comprising:
receiving a requisition input indicative of a recruiting requisition and a set of recruiting personnel;
opening a recruiting requisition record corresponding to the recruiting requisition;
outputting a private group output creating a private group in a social network corresponding to the recruiting requisition;
adding the recruiting personnel to the private group in the social network;
receiving user event inputs that generate a user-initiated recruiting event;
outputting a thread manipulation output manipulating a thread, corresponding to a candidate, in the private group in the social network.

20. The computer readable medium of claim 19 wherein receiving a requisition input, outputting a private group output, adding the recruiting personnel to the private group in the social network, receiving user event inputs and outputting a thread manipulation output are performed in a recruiting system and wherein opening a recruiting requisition record is performed in a business system.
